(19) United States
(12) Patent Application Publication
(10) Pub. No.: US 2025/0144893 A1
(43) Pub. Date: May 8, 2025

(54) METHOD AND FACILITY FOR MANUFACTURING A VACUUM-MOLDED PART

(71) Applicants: CORSO MAGENTA, Nanterre (FR); NANTES UNIVERSITE, Nantes (FR)

(72) Inventors: Sebastien ROY, Le Thor (FR); Gwendal HUET, Nanterre (FR); Stanislas CHEVALLIER; Pascal CASARI, Saint-Nazaire (FR)

(21) Appl. No.: 18/837,077

(22) PCT Filed: Feb. 9, 2023
(86) PCT No.: PCT/IB2023/051174

§ 371 Date: Aug. 8, 2024

(30) Foreign Application Priority Data
Feb. 9, 2022 (FR) FR2201124

(51) Int. Cl. B29C 70/44; B29C 70/08; B29C 70/48; B29C 70/78

(52) U.S. Cl. CPC B29C 70/443; B29C 70/086; B29C 70/48; B29C 70/78

(57) ABSTRACT

A method for manufacturing a part comprises the following steps:
providing a molding element (100) and an airtight flexible sheet (200) consisting of a film comprising a dry layer (201) of a paint-type material integral with a backing (202) provided with anchoring arrangements on the side opposite to the layer of paint-type material, the backing facing towards the molding element and the sheet being unsupported and peripherally connected to the rigid molding element in an airtight manner so that they between them define a molding zone the shape of which is generally defined by the molding element,
introducing a solidifiable molding material in a viscous state into the molding zone,
prior to, simultaneously with or subsequent to said introduction of the molding material, applying a vacuum (120-122) in the molding zone,
causing the molding material (R) to solidify, and
extracting from the molding zone an article (P) comprising the solidified molding material in which the film is anchored, where the dry layer of paint-type material of said film is exposed to the outside.

### FIELD OF THE INVENTION

The present invention generally relates to the manufacture of molded components.

### PRIOR ART

There are numerous techniques for manufacturing volumic parts by filling a molding zone or cavity with a liquid or viscous material and then setting or curing the material.

It may involve components injected by a thermoplastic or thermosetting material, resin infusion into a mold where structuring elements have been incorporated (in particular mineral fibers such as glass fabric, etc.), molded concrete elements, etc.

In the particular case of a method of the infusion type, a resin is introduced into the mold cavity in which the structuring elements have been placed, this cavity is exposed to a vacuum source at one or more points, so that the resin, from the point or points of introduction, propagates through the entire extent of the cavity.

To achieve this, an airtight flexible sheet (also known as a vacuum bag) is applied over the structuring elements and tightly connected to the mold around its entire periphery.

It is then necessary to remove this airtight sheet.

In the case where the raw appearance of the surface of the part on the airtight sheet side poses no difficulty, particularly in relation to the type of part being produced (as in the case of the inside of a boat hull), it is left as-is.

But in other cases, it is necessary to apply a finishing treatment (paint, gelcoat, etc.) to this rough surface, which requires an additional step in the manufacture of the part.

It should be noted that here the mold defines only one face of the part, the other face being defined at the airtight flexible sheet. This excludes methods using two rigid mold parts placed close together and defining a closed molding space, as for example in US2008206540A1.

### SUMMARY OF THE INVENTION

The aim of the present invention is to simplify the manufacture of the part when it must, on its raw face corresponding to the side where the airtight sheet of the vacuum bag type is applied, have a certain appearance and/or functionality.

To this end, a method for manufacturing a part is proposed, of the type comprising the following steps:
providing a rigid molding element suitable for shaping one face of the part and an airtight flexible sheet preconstituted of a film comprising a dry layer of a paint-type material secured to a backing provided with anchoring arrangements on the side opposite to the layer of a paint-type material, the backing facing towards the molding element, and said sheet being unsupported and being peripherally connected to the rigid molding element in an airtight manner so that between them alone they define a molding zone whose shape is generally defined by the molding element,
introducing a solidifiable molding material in a viscous state into the molding zone,
prior to, simultaneously with or subsequent to said introduction of the molding material, applying a vacuum in the molding zone,
causing the molding material to solidify, and
extracting from the molding zone an article comprising the solidified molding material, in which the film is anchored, where the dry layer of a paint-type material of said film is exposed to the outside.

Preferred but non-limiting aspects of this method comprise the following additional features:
the method also comprises a step, prior to introducing the molding material and applying the vacuum, consisting in placing a reinforcing material, intended to be embedded in the molding material, in the molding zone.
the molding material consists of a resin, in particular an impregnable resin. “Resin” here means any natural, artificial or synthetic product capable of curing by polymerization under given conditions which differ according to the type of resin.
introducing the resin is carried out by a process included in the following group: infusion, pre-impregnation, contact molding, resin transfer molding, filament winding.
the backing of the film is a fibrous backing, with loose or structured fibers, the anchoring arrangements comprising fibers protruding from the layer of paint-type material. These fibers can be of any type, shape or size, provided that at least some of them are anchored in the molding material as it progresses through the zone
the molding element and the airtight sheet protrude beyond the contours of the part to be produced by marginal zones.
the method comprises a step of peripheral cutting of the part to remove the material corresponding at least partly to said marginal zones.
the vacuum source is connected to the molding zone by at least one vacuum port passing through said film.
the method also comprises a step prior to the step of introducing the molding material, consisting in arranging against the molding element a further sheet comprising a dry layer of a paint-type material integral with a backing provided with anchoring arrangements on the side opposite to the layer of paint-type material, the backing facing the airtight flexible sheet.
the film forming the airtight flexible sheet and the other film are identical.

According to a second aspect, a facility is proposed for manufacturing a component with a molding material, comprising:
a rigid molding element capable of shaping one face of the part,
an airtight flexible sheet, unsupported and peripherally connected to the rigid molding element in an airtight manner so that they alone define between them a molding zone whose shape is generally defined by the molding element,
a vacuum source connected to the molding zone, so that a vacuum can be applied in the molding zone while molding material is being introduced into said zone or afterward,

the facility being characterized in that the airtight flexible sheet is preconstituted of a film comprising a dry layer of a paint-type material secured to a backing provided with anchoring arrangements on the side opposite to the layer of a paint-type material, the backing facing towards the molding element and being capable of anchoring in the molding material as the latter spreads through the molding zone.

Preferred but non-limiting aspects of this facility include the following additional features:
the facility also comprises a reinforcing material placed in the molding zone and intended to be embedded in the molding material.
the molding material consists of a resin, in particular an impregnable resin, or a thermoplastic polymer in the molten state.
introducing the resin is carried out by a process included in the following group: infusion, pre-impregnation, contact molding, resin transfer molding, filament winding.
the backing of the film is a fibrous backing, the anchoring arrangements comprising fibers protruding from the layer of a paint-type material.
the molding element and the airtight sheet protrude beyond the contours of the part to be produced by marginal zones.
the vacuum source is connected to the molding zone by at least one vacuum port passing through said film.

Finally, use is proposed of a pre-constituted film of a dry layer of a paint-type material anchored in a backing provided with anchoring arrangements on the side opposite to the layer of a paint-type material, for its application against a face of a part opposite a mold element while being unsupported, in order to define between the film and the mold element, on their own, a sealed molding space into which molding material can be introduced and in which vacuum can be applied.

### BRIEF DESCRIPTION OF THE DRAWINGS

Other aspects, aims, and advantages of the present invention will become more apparent on reading the following detailed description of preferred embodiments thereof, given by way of non-limiting example and made with reference to the accompanying drawings, in which:

FIG. 1 is a schematic top view of a facility for manufacturing a part by a so-called infusion method according to the invention,

FIG. 2 is a schematic view in longitudinal section of the facility of FIG. 1,

FIG. 3 is a schematic top view of the finished part, after trimming,

FIG. 4 is a schematic view in longitudinal section of the part of FIG. 3,

FIG. 5 is an enlarged cross-sectional view of a film used in the facility of FIGS. 1 and 2, and

FIG. 6 is an enlarged cross-sectional view of a portion of the finished part in which the film is anchored.

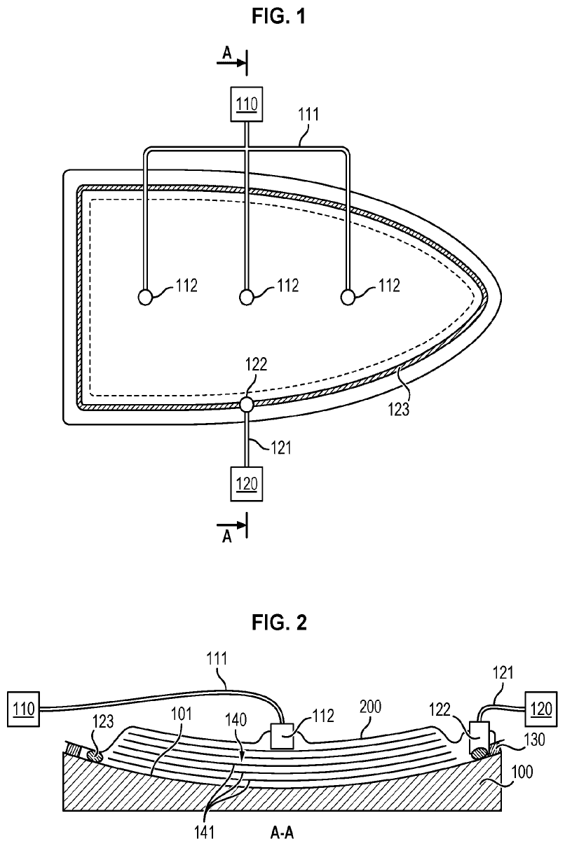

Note that the vertical scales in the drawings do not necessarily reflect reality, but have been adapted for a clear understanding of the invention.

### DETAILED DESCRIPTION OF AN EMBODIMENT

With reference to the Figures, we will now schematically describe a method for producing a three-dimensional part according to one exemplary embodiment of the invention.

The facility firstly comprises a rigid mold 100 for the part comprising a mold bottom 101 defining the external shape of the part to be produced, a container or tank 110 containing a resin R intended to form the part, and a set of pipes 111 connecting the container 110 to a set of injection points 112 provided in an unsupported airtight sheet 200, which will be described in more detail below, placed above the mold 100.

“Unsupported” means that the airtight sheet is not backed by a rigid mold part that would be pressed against the mold bottom 101 before the resin is introduced.

The injection points 112 each typically comprise a fitting sealingly mounted in the airtight sheet and able to place the corresponding end of the counterpart pipe 111 in communication with a mold cavity jointly defined by the rigid mold 100 and the airtight sheet 200.

The facility further comprises a vacuum pump 120 connected via a vacuum line 121 to one or more vacuum application points 122. This vacuum application point is in communication with a peripheral zone 123 of the mold cavity, formed by a bead of incompressible air-permeable material such as draining felt, draining mesh or spiral tubing. This zone 123 is designed to distribute the application of vacuum over the entire periphery of the molding cavity to ensure even progress of the resin R during the infusion process.

Reference 130 designates a thick, highly deformable adhesive tape designed to provide a seal between the periphery of the airtight sheet 200 and the periphery of the mold 100, this tape being arranged on the outside of the incompressible bead forming the zone 123.

The facility further comprises a core material 140 for the part to be produced, arranged between the bottom of the mold 100 and the airtight sheet 200. This material typically comprises one or more layers 141 of a reinforcing and/or stiffening material, such as superimposed webs of a fabric such as a glass or carbon fabric. Advantageously, one or more drain-forming webs can also be provided, generally thicker and more perforated than the reinforcing material 140, designed in a manner known per se to facilitate resin flow to all zones of the part during the infusion process. The drainage means may further comprise a low-density foam forming channels for the resin.

The part is made by causing the resin R contained in the container 110 to enter the mold cavity defined between the mold bottom 101 and the airtight sheet 200, and propagating into the cavity in a manner promoted by the application of vacuum.

Once the resin R has solidified, the various components of the facility are removed, and the part P, consisting of the resin R in which the core material 140 is embedded, as well as the film 200, is removed from the mold.

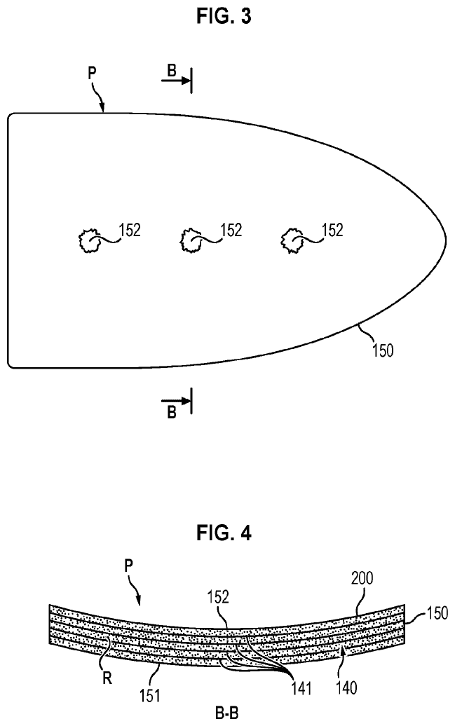

The part is then trimmed to remove its marginal parts (trimmed area 150 on FIGS. 3 and 4), with the mold side of the part being designated by reference 151.

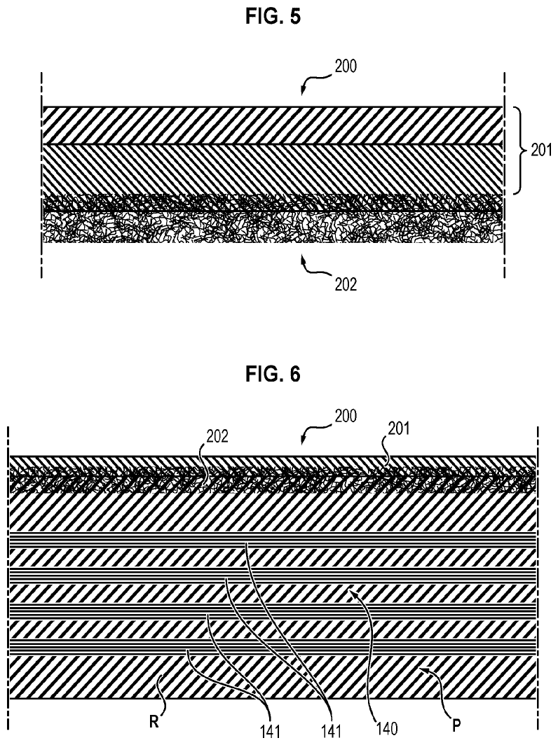

According to one aspect of the invention, and with reference to FIG. 5, the airtight sheet 200 consists of a film comprising a portion 201 comprising one or more dry layers of a paint-type material, integral with a backing 202 provided with anchoring arrangements on the side opposite to the layer of paint-type material, the backing facing the mold 100, and this film being, as stated, peripherally connected to the mold 100 in an airtight manner, using means similar to those used for a conventional airtight sheet of the vacuum bag type.

The term “paint-type material” is understood here to mean a material which is opaque (pigmented) or transparent or translucent (varnish) which is applied normally in liquid or gel form, in contrast in particular to thin single-layer or laminated plastic films.

This film is made, for example, in accordance with the teachings of document WO2016110799A1. If necessary, these sealing means (thickness, malleability, adhesion forces, etc.) are adapted to take account of the fact that film 200 may have greater rigidity than a conventional airtight sheet, which is generally thinner and more flexible.

In this way, during the process, the film 200, thanks to the vacuum, is pressed closely against the resin being infused, and once the process is complete and the resin has set, the top face of the part (opposite side to the mold 100) has, in a manner closely linked to the structure of the part thanks to the backing, an integrated decorative and/or functional (in cases where the dry paint has particular properties) layer. FIG. 6 shows the part P made up of resin R, in which the core elements 140 are embedded and on whose surface (opposite the mold) the film 200 is firmly anchored, the fibers of the backing 202 which initially protruded from the film portion 201 being at least partially trapped in the resin R. In this way, the film 200 acts both as a airtight sheet (“vacuum bag” in the manufacturing process) and as a finishing layer for the part on the same side. This layer can have various functions: decoration, protection, but also functionalization of the surface of the component by incorporation with the layer or layers of paint of particular layers, as described, for example, in various patents published in the name of the company Corso Magenta.

Note that in the shown embodiment, the resin introduction points 112 pass through the film 200 at locations remote from the part's periphery.

In practice, these points of introduction can be arranged either as shown, or on the periphery, or in a combination of such locations, the choice being dictated in particular by the shape and dimensions of the part.

In a non-shown variant, it is also possible, prior to the step of introducing the molding material, to place a further film identical or similar to the film 200 against the mold 100, so that this additional film is anchored in the resin R on the opposite side of the part, thus giving it a particular appearance and/or functionality.

The invention, the basic principle of which has been described above, is open to numerous variants and modifications.

In particular:
the material 123 forming incompressible zones can also be provided along the length of the part to form distribution channels for both resin circulation and vacuum distribution; more generally, the arrangement of drains and such channels will be designed by the person skilled in the art as a function of the various constraints present (shape and dimensions of the part, viscosity of the resin, etc.) to optimize the progression of the resin front(s);
The zones 152 of the part P corresponding to the locations of the resin injection points 112 can, if necessary, be subjected to any special treatment, such as further painting, after the part has been produced;
the back 202 of the film 200 can be designed to contribute to this function of controlling the resin front(s), by designing the back in a particular way (thickness, material density, shape and arrangement of fibers, etc.).
when the size of the part to be manufactured is such that two or more strips of film 200 have to be juxtaposed, it is necessary to ensure a seal between the homologous edges of two adjacent strips; different approaches can be envisaged, in particular overlapping the edges with the interposition of an adhesive.

A certain number of examples of materials and parameters which can be used in an infusion method as described above will now be given.
type of resin infused: Bi-component resins such as epoxy, polyester, vinyl-ester resins, possibly biosourced, thermosetting resins or thermoplastic resins such as acrylic resins, in particular those marketed under the Elium® brand by Arkema;
type of reinforcing material 300:
in sheets or layers: fabrics (taffeta, satin, twill, mesh, knit, etc), nonwovens,
particulate: glass fibers or grains, carbon, aramid, Kevlar®, linen, with weights of approximately 20 to 600 g/m2,
type of paint of the film 200 and range of thicknesses: two-component (epoxy or polyurethane) or mono-component (acrylic, epoxy, polyurethane); thickness of the order of 30 to 120 μm; it will be noted here that in the case where the infusion method involves heating, or in the case where the setting of the resin generates heat, the nature of the paint and, where appropriate, of its fibrous backing is chosen;
type of fibrous backing of the film 200, density and thickness: fabric, glass particles or mat, carbon, aramid, Kevlar®, linen in various forms, with a weight of approximately 15 to 150 g/m2,

More generally, it will be noted that the nature and thickness of the fibrous backing of the film are chosen so that they are adapted to the nature and the viscosity of the resin. In particular, the texture, density, and thickness of the free part of the backing 202 of the film 200 can be chosen depending in particular on the viscosity and the other properties of the resin when it comes into contact with the film, in particular so that this material properly fills this free part and that effective anchoring is ensured. For example, the more viscous the resin, the more aerated its texture.

Of course, the present invention is by no means limited to the embodiment described and shown in the drawings; rather, numerous variants or modifications are possible.

In particular, the invention can be applied, without limitation, to any of the following methods: infusion, pre-impregnation, contact molding, transfer molding, based on resin or thermoplastic polymer in the molten state, filament winding, to manufacture various parts and in particular parts of large dimensions in length and width compared to their thickness, such as boat hulls, wind turbine propeller blades, etc.

1. A method for manufacturing a part, comprising the following steps:
providing a rigid molding element suitable for shaping one face of the part and an airtight flexible sheet preconstituted of a film comprising a dry layer of a paint-type material secured to a backing provided with anchoring arrangements on the side opposite to the layer of paint-type material, the backing facing towards the molding element, and said sheet being unsupported and being peripherally connected to the rigid molding element in an airtight manner so that between them alone they define a molding zone whose shape is generally defined by the molding element,
introducing a solidifiable molding material in a viscous state into the molding zone,
prior to, simultaneously with or subsequent to said introduction of the molding material, applying a vacuum in the molding zone,
causing the molding material to solidify, and
extracting from the molding zone an article comprising the solidified molding material, in which the film is anchored, where the dry layer of paint-type material of said film is exposed to the outside.

2. The method according to claim 1, further comprising a step consisting in placing in the molding zone, prior to introducing the molding material and applying the vacuum, a reinforcing material, intended to be embedded in the molding material.

3. The method according to claim 1, wherein the molding material consists of a resin, in particular an impregnable resin.

4. The method according to claim 3, wherein the step of introducing the resin is carried out by a process included in the following group: infusion, pre-impregnation, contact molding, resin transfer molding, filament winding.

5. The method according to claim 1, wherein the film backing is a fibrous backing, the anchoring arrangements comprising fibers protruding from the layer of paint-type material.

6. The method according to claim 1, wherein the molding element and the airtight sheet protrude beyond the contours of the part to be produced by marginal areas.

7. The method according to claim 6, further comprising a step of peripherally cutting of the part to remove the material corresponding at least partly to said marginal zones.

8. The method according to claim 1, wherein the vacuum source is connected to the molding zone by at least one vacuum port passing through said film.

9. The method according to claim 1, further comprising a step prior to the step of introducing the molding material, consisting in arranging against the molding element a further sheet comprising a dry layer of a paint-type material integral with a backing provided with anchoring arrangements on the side opposite to the layer of paint-type material, the backing facing the airtight flexible sheet.

10. The method according to claim 9, wherein the film constituting the airtight flexible sheet and the other film are identical.

11. A facility for manufacturing a component with a molding material, comprising:
a rigid molding element capable of shaping one face of the part,
an airtight flexible sheet, unsupported and peripherally connected to the rigid molding element in an airtight manner so that they alone define between them a molding zone whose shape is generally defined by the molding element,
a vacuum source connected to the molding zone, so that a vacuum can be applied in the molding zone while molding material is being introduced into said zone or afterward,
wherein the airtight flexible sheet is preconstituted of a film comprising a dry layer of a paint-type material integral with a backing provided with anchoring arrangements on the side opposite to the layer of paint-type material, the backing facing towards the molding element and being capable of anchoring in the molding material as the latter spreads through the molding zone.

12. The facility according to claim 11, further comprising a reinforcing material placed in the molding zone and intended to be embedded in the molding material.

13. The facility according to claim 11, wherein the molding material consists of a resin, in particular an impregnable resin.

14. The facility according to claim 13, wherein the introduction of the resin is carried out by a process included in the following group: infusion, pre-impregnation, contact molding, resin transfer molding, filament winding.

15. The facility according to claim 11, wherein the film backing is a fibrous backing, the anchoring arrangements comprising fibers protruding from the layer of paint-type material.

16. The facility according to claim 11, wherein the molding element and the airtight sheet protrude beyond the contours of the part to be produced by marginal areas.

17. The facility according to claim 11, wherein the vacuum source is connected to the molding zone by at least one vacuum port passing through said film.

18. The use of a pre-constituted film of a dry layer of a paint-type material anchored in a backing provided with anchoring arrangements on the side opposite to the layer of paint-type material, for its application against a face of a part opposite a mold element while being unsupported, in order to define between the film and the mold element, on their own, a sealed molding space into which molding material can be introduced and in which vacuum can be applied.
